(19) United States
(12) Patent Application Publication
(10) Pub. No.: US 2026/0252882 A1
(43) Pub. Date: Aug. 27, 2026

(54) DEVICE AND METHOD FOR LEARNING NEURAL NETWORKS USING CONTENT-BASED NEURAL NETWORK WEIGHTS

(71) Applicant: Hansung University Industry-University Cooperation Foundation, Seoul (KR)

(72) Inventor: Jongtaek Oh, Seoul (KR)

(73) Assignee: Hansung University Industry-University Cooperation Foundation, Seoul (KR)

(21) Appl. No.: 19/548,892

(22) Filed: Feb. 24, 2026

Related U.S. Application Data
(60) Provisional application No. 63/762,286, filed on Feb. 24, 2025.

(51) Int. Cl. G06N 3/08

(52) U.S. Cl. CPC G06N 3/08

(57) ABSTRACT

A computer-implemented neural network training system is disclosed in which a data preprocessing parameter set and a model parameter set are jointly managed and iteratively updated within a unified execution control structure. One or more hardware processors execute instructions stored in non-transitory memory to perform a preprocessing process on raw data using the data preprocessing parameter set, train a neural network model using preprocessed data and the model parameter set, compute a loss value representing an estimation error, and update both the data preprocessing parameter set and the model parameter set based on the loss value. The processors iteratively repeat these operations under control of an iteration control logic until a stopping criterion is satisfied. Accordingly, preprocessing configuration and model configuration are dynamically co-optimized through coordinated modification of structured data stored in memory within a single computing system.

### CROSS REFERENCE TO RELATED APPLICATION

This application claims the benefit of the filing date of U.S. Patent Provisional Application No. 63/762,286, filed February 24, 2025, as Attorney Docket No.: 985.0008prov, the teaches of which are incorporated herein their entirety by reference.

### BACKGROUND

The present disclosure relates generally to computer-implemented machine learning systems, and more particularly to a neural network training architecture in which data preprocessing operations and neural network model training operations are integrally controlled and optimized within a computing system.

The present disclosure relates to artificial intelligence and deep learning systems, and more particularly to a processor-controlled system and method for retrieving stored neural network parameter sets and reinitializing a neural network using content-based parameter similarity within a computing environment.

Neural networks are widely deployed in computational platforms including image processing systems, speech recognition systems, natural language processing systems, autonomous control systems, and large-scale data analysis infrastructures. In certain architectures, a neural network is trained for a designated task using a corresponding dataset, and the resulting structured parameter set is stored in memory for later execution or reuse.

When a new task or modified dataset is introduced, existing systems often initialize a neural network using arbitrary parameter values or manually selected pre-trained models. Such initialization approaches may require repeated training iterations and extensive rewriting of structured parameter sets stored in memory. As model size and parameter dimensionality increase, repeated initialization and retraining operations may result in increased processor utilization, expanded memory access cycles, and inefficient coordination between stored model repositories and active training modules.

In certain system configurations, transfer learning techniques are applied in which parameters from a previously trained neural network are reused for a related task. However, such approaches generally depend on structural similarity between models or similarity between application domains, and frequently involve manual configuration of parameter reuse. These processes may introduce operational inefficiencies in distributed computing environments and may not scale effectively when multiple heterogeneous neural network parameter sets are stored in a shared database structure.

Accordingly, there exists a need for a processor-executed mechanism capable of automatically retrieving structurally relevant neural network parameter sets from memory, coordinating structured parameter rewriting operations, and controlling reinitialization during neural network training without manual model selection.

### SUMMARY

In accordance with one aspect of the present disclosure, a computer-implemented neural network learning method is provided in which one or more features representing structural or parametric characteristics of a given neural network are extracted, and one or more candidate structured parameter sets are automatically retrieved from a parameter repository based on content-derived similarity using the extracted features.

In accordance with another aspect of the present disclosure, the retrieved candidate structured parameter sets are aligned or transformed to conform to a structure of the given neural network, and at least a portion of a structured parameter set stored in non-transitory memory is rewritten by applying the aligned structured parameter sets as initial parameter values.

In accordance with still another aspect of the present disclosure, a processor-controlled execution framework is provided in which similarity evaluation, parameter alignment, parameter rewriting, and iterative training control are dynamically performed, and additional candidate structured parameter sets may be retrieved when a predetermined training condition is not satisfied.

In accordance with an embodiment, a computer-implemented neural network learning method using content-based neural network parameter sets, performed by at least one hardware processor operatively coupled to a non-transitory memory, may be provided. The method may include: reading, by the at least one hardware processor, a structured parameter set corresponding to a given neural network from the non-transitory memory; extracting, by the at least one hardware processor, one or more features representing structural or parametric characteristics of the given neural network; retrieving, by the at least one hardware processor, one or more candidate structured parameter sets from a parameter repository stored in the non-transitory memory by using at least some of the one or more features as a search key; adjusting, by the at least one hardware processor, the one or more candidate structured parameter sets to conform to a structure of the given neural network; and rewriting, by the at least one hardware processor, at least a portion of the structured parameter set of the given neural network in the non-transitory memory by applying the adjusted structured parameter sets as initial parameter values, and performing training of the given neural network using the rewritten structured parameter set.

In accordance with another embodiment, a neural network training system using content-based neural network parameter sets may be provided. The system may include at least one hardware processor; and a non-transitory memory storing executable instructions and a parameter repository including structured parameter sets corresponding to a plurality of pre-constructed neural networks, wherein the executable instructions, when executed by the at least one hardware processor, cause the at least one hardware processor to: extract one or more features representing structural or parametric characteristics of a given neural network; retrieve one or more candidate structured parameter sets from the parameter repository by using at least some of the one or more features as a search key; adjust the one or more candidate structured parameter sets based on a structure of the given neural network; and rewrite at least a portion of a structured parameter set stored in the non-transitory memory and train the given neural network using the rewritten structured parameter set.

### BRIEF DESCRIPTION OF THE DRAWINGS

FIG. 1 is a diagram illustrating a neural network learning system according to an embodiment of the present disclosure.

FIG. 2 is a diagram illustrating a system configuration of a neural network learning apparatus according to an embodiment of the present disclosure.

FIG. 3 is a diagram illustrating a functional configuration of a neural network learning apparatus according to an embodiment of the present disclosure.

FIG. 4A is a flowchart illustrating a neural network learning method using content-based neural network weights according to an embodiment of the present disclosure.

FIG. 4B is a diagram illustrating an execution-oriented structure in which structured parameter sets are retrieved, aligned, rewritten, and iteratively controlled under processor control according to an embodiment of the present disclosure.

FIG. 5 is a diagram illustrating a model structure of a neural network according to an embodiment of the present disclosure.

### DETAILED DESCRIPTION OF EMBODIMENTS

The present disclosure provides a processor-controlled neural network training system in which stored parameter sets of previously trained neural networks are retrieved, aligned, and reinitialized within a unified execution control structure. In particular, the disclosed system treats neural network parameters as structured data sets stored in memory and selectively rewritten under control of one or more hardware processors based on content-derived similarity metrics. Rather than performing independent training from arbitrary initial parameter states, the system dynamically retrieves structurally relevant parameter sets and coordinates parameter rewriting and reinitialization operations during controlled training iterations.

In the disclosed architecture, a first parameter set generated through preliminary training of a target neural network is converted into a structured feature representation and compared against a repository of stored neural network parameter sets. One or more candidate parameter sets are selected based on similarity evaluation, structurally aligned with the target network architecture, and selectively merged or substituted within memory. The processor executes iterative training operations while monitoring an estimation error value and, when predetermined control conditions are satisfied, triggers additional retrieval and parameter rewriting operations. As a result, neural network configuration and parameter initialization are dynamically co-managed within a unified computing system rather than being statically predetermined prior to training.

The embodiments of the present disclosure will now be described in detail with reference to the accompanying drawings.

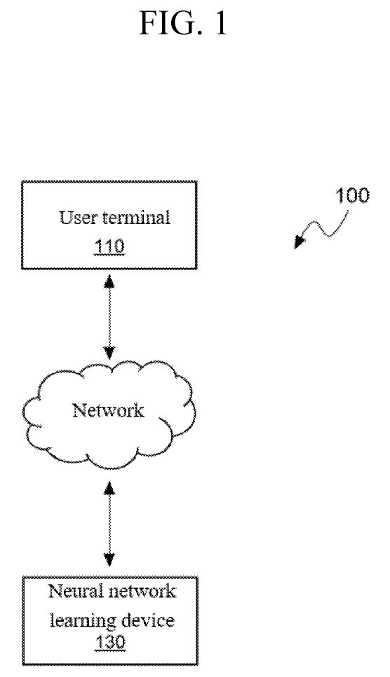

FIG. 1 is a diagram illustrating a neural network learning system according to the present disclosure.

Referring to FIG. 1, a neural network learning system 100 may include a user terminal 110 and a neural network learning apparatus 130. The neural network learning system 100 may provide a device and method for efficiently retrieving weights of an existing neural network and utilizing the retrieved weights for learning of a new neural network.

Here, a neural network may correspond to a multilayer computational model forming a neural network structure composed of nodes and edges. For example, the neural network may include an artificial neural network (ANN), a convolutional neural network (CNN), a recurrent neural network (RNN), and a long short-term memory (LSTM) network, without being limited thereto. Each node of the neural network may correspond to an artificial neuron configured to process input data and generate an output and may adjust the output through a bias. In addition, each edge of the neural network may be at least one of a forward path, a reverse path, and a recurrent edge between nodes in the same layer, and a weight may be assigned thereto.

The user terminal 110 may correspond to a terminal device operated by a user. In an embodiment of the present disclosure, the user may be understood as one or more users, and each of the one or more users may correspond to one or more user terminals 110. That is, although one user terminal 110 is illustrated in FIG. 1, a first user may correspond to a first user terminal, a second user may correspond to a second user terminal, and an n-th user (where n is a natural number) may correspond to an n-th user terminal.

In addition, the user terminal 110 may be implemented as a device constituting the neural network learning system 100 according to the present disclosure, and the neural network learning system 100 may be modified and implemented in various forms according to the purpose of neural network learning using content-based neural network weights. Further, the user terminal 110 may be implemented as a smartphone, a notebook, or a computer operably connected to the neural network learning apparatus 130, but is not limited thereto, and may also be implemented as various devices including a tablet PC. The user terminal 110 may install and execute a dedicated program or application in order to interoperate with the neural network learning apparatus 130. The user terminal 110 may be connected to the neural network learning apparatus 130 through a network, and a plurality of user terminals 110 may be simultaneously connected to the neural network learning apparatus 130.

For purposes of clarity, the neural network learning apparatus 130 may also be referred to as a neural network training system or a computing system, and may include one or more hardware processors and non-transitory memory storing executable instructions. The term “weight” as used herein may refer to a structured parameter set stored in memory and processed by one or more processors during execution of neural network training operations. These alternative expressions are used interchangeably to describe equivalent structural and functional components.

In certain embodiments, the neural network learning apparatus 130 may maintain in memory a repository of previously trained neural network parameter sets corresponding to different training tasks. The processor may convert parameters of a target neural network into a structured feature representation, compare the structured representation with stored parameter sets, and retrieve one or more candidate parameter sets based on content-derived similarity metrics. The processor may dynamically align and rewrite structured parameter sets stored in memory to reinitialize the target neural network within a controlled iteration framework.

In certain embodiments, a trained neural network model generated by the neural network learning apparatus 130 may be deployed in a separate inference environment for execution. Such an inference environment may include one or more processors configured to execute the trained neural network model using the parameter set generated during training. The inference environment may generate output results based on input data and may optionally transmit feedback information to the neural network learning apparatus 130. Such deployment does not alter the structured parameter retrieval and reinitialization architecture described herein and may operate independently of the parameter repository maintained by the neural network learning apparatus 130.

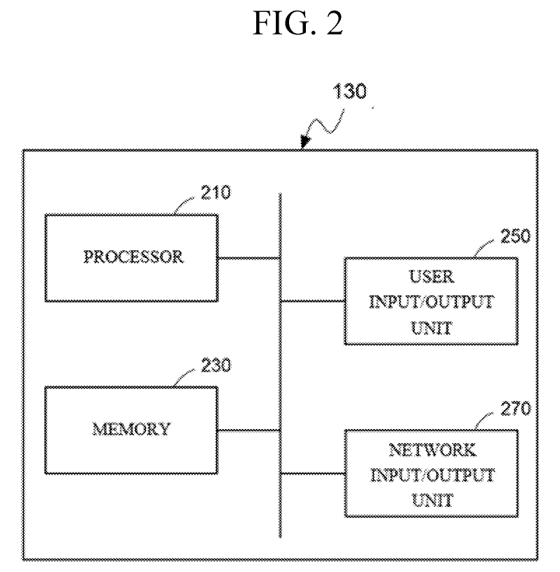

FIG. 2 is a diagram illustrating an embodiment of a system configuration of a neural network learning apparatus according to the present disclosure.

Referring to FIG. 2, the neural network learning apparatus 130 may include a processor 210, a memory 230, a user input/output unit 250, and a network input/output unit 270.

The processor 210 may execute procedures for performing the neural network learning method using content-based neural network weights, may manage the memory 230 read or written during such processes, and may schedule synchronization time between volatile memory and non-volatile memory in the memory 230. The processor 210 may control overall operations of the neural network learning apparatus 130 and may be electrically connected to the memory 230, the user input/output unit 250, and the network input/output unit 270 to control data flow therebetween. The processor 210 may be implemented as a CPU (Central Processing Unit), a GPU (Graphic Processing Unit), or an NPU (Neural Processing Unit), but is not limited thereto.

The memory 230 may include a secondary storage device implemented as non-volatile memory such as an SSD (Solid State Disk) or an HDD (Hard Disk Drive) and used to store overall data required by the neural network learning apparatus 130 and may include a main memory implemented as volatile memory such as RAM (Random Access Memory). In addition, the memory 230 may store a set of instructions for execution of the neural network learning method using content-based neural network weights, and the instructions may be executed by the processor 210.

The user input/output unit 250 may include an environment for receiving user input and an environment for outputting specific information to the user and may include, for example, an input device including an adapter such as a touch pad, a touch screen, a virtual keyboard, or a pointing device, and an output device including an adapter such as a monitor or a touch screen. In one embodiment, the user input/output unit 250 may correspond to a terminal accessed through remote connection, and in such a case, the neural network learning apparatus 130 may correspond to an independent node of the network to which the terminal is connected.

The network input/output unit 270 may provide a communication environment for connection with other devices through a network and may include, for example, an adapter for communication such as LAN (Local Area Network), MAN (Metropolitan Area Network), WAN (Wide Area Network), or VAN (Value Added Network). In addition, the network input/output unit 270 may be implemented to provide short-range communication functions such as WiFi and Bluetooth or wireless communication functions of 4G or higher for wireless data transmission.

For purposes of clarity, the neural network learning apparatus 130 may be implemented as a neural network training system including one or more hardware processors and non-transitory memory storing executable instructions. The term “weight” as used herein may refer to a structured parameter set stored in the memory 230 and processed by one or more processors during execution of neural network training operations. The user input/output unit 250 may be implemented as a user interface module operatively coupled to the processor 210. The network input/output unit 270 may be referred to as network interface circuitry. These alternative expressions are used interchangeably to describe equivalent structural and functional components.

In certain embodiments, the processor 210 may execute one or more circuitry modules implemented in hardware, firmware, software, or a combination thereof to perform feature extraction, parameter retrieval, parameter alignment, parameter rewriting, and iterative training control operations. The memory 230 may maintain a repository of previously trained neural network parameter sets corresponding to different training tasks. During execution, the processor 210 may selectively access, compare, align, and rewrite structured parameter sets stored in the memory 230 based on content-derived similarity metrics and predefined control conditions. Accordingly, FIG. 2 represents a processor-controlled architecture in which structured parameter sets are dynamically managed within a memory-based execution framework.

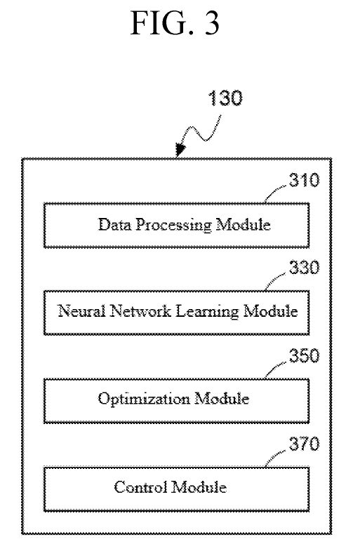

FIG. 3 is a diagram illustrating an embodiment of a functional configuration of a neural network learning apparatus according to the present disclosure.

Referring to FIG. 3, the neural network learning apparatus 130 may perform a neural network learning method using content-based neural network weights according to the present disclosure. For this purpose, the neural network learning apparatus 130 may include a feature extraction unit 310, a weight retrieval unit 330, a weight adjustment unit 350, and a neural network learning unit 370.

In this case, the embodiment of the present disclosure does not necessarily include all of the above-described components simultaneously, and depending on the embodiment, some of the above-described components may be omitted, or some or all of the above-described components may be selectively included. Hereinafter, operations of the respective components will be described in detail.

The feature extraction unit 310 may extract one or more features from a given neural network.

The weight retrieval unit 330 may retrieve candidate weights of the given neural network from a weight database storing weights of pre-constructed neural networks by using at least some of the one or more features as a search key.

The weight adjustment unit 350 may adjust the candidate weights based on the given neural network.

The neural network learning unit 370 may train the given neural network by applying the adjusted candidate weights as initialization values.

For purposes of clarity, the feature extraction unit 310, the weight retrieval unit 330, the weight adjustment unit 350, and the neural network learning unit 370 may be implemented as functional modules executed by one or more hardware processors. The term “weight” as used herein may refer to a structured parameter set stored in non-transitory memory and processed by one or more processors during execution of neural network training operations. These alternative expressions are used interchangeably to describe equivalent structural and functional components.

In certain embodiments, the processor 210 described in FIG. 2 may include one or more circuitry modules configured to perform the operations associated with the feature extraction unit 310, the weight retrieval unit 330, the weight adjustment unit 350, and the neural network learning unit 370. The feature extraction circuitry may convert parameters of a target neural network into a structured feature representation stored in memory. The parameter retrieval circuitry may compare the structured representation with parameter sets stored in a repository and retrieve one or more candidate parameter sets based on content-derived similarity metrics. The parameter alignment circuitry may structurally align and rewrite selected parameter sets within memory to generate a reinitialized parameter set. The training circuitry may execute iterative training control logic that updates the structured parameter set and rewrites the updated parameters in memory during controlled training iterations. Accordingly, FIG. 3 represents a processor-centric architecture in which functional components are executed as circuitry modules under coordinated parameter management and iterative control.

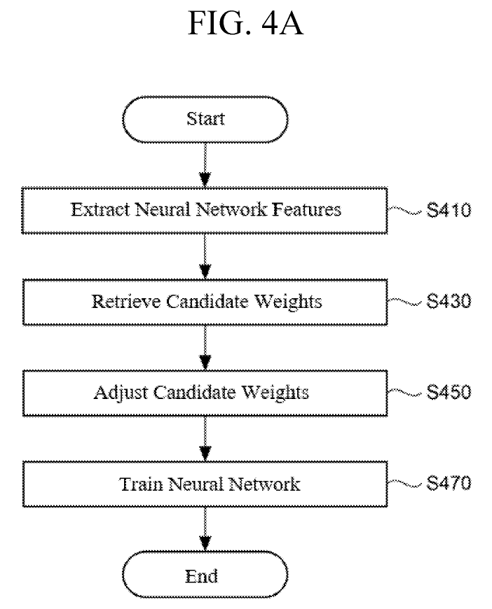

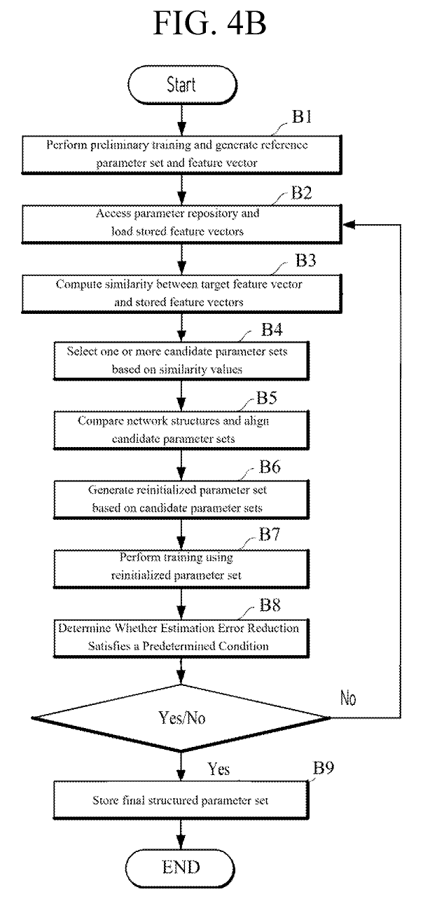

FIG. 4A is a flowchart illustrating a neural network learning method using content-based neural network weights according to the present disclosure.

Referring to FIG. 4A, the neural network learning apparatus 130 may extract one or more features from a given neural network through the feature extraction unit 310 (step S410). The neural network learning apparatus 130 may retrieve candidate weights of the given neural network from a weight database storing weights of pre-constructed neural networks by using at least some of the one or more features as a search key through the weight retrieval unit 330 (step S430). The neural network learning apparatus 130 may adjust the candidate weights based on the given neural network through the weight adjustment unit 350 (step S450). The neural network learning apparatus 130 may train the given neural network by applying the adjusted candidate weights as initialization values through the neural network learning unit 370 (step S470).

For purposes of clarity, the term “weight” as used herein may refer to a structured parameter set stored in non-transitory memory and processed by one or more hardware processors during execution of neural network training operations. The feature extraction unit 310, the weight retrieval unit 330, the weight adjustment unit 350, and the neural network learning unit 370 may be implemented as functional modules executed by one or more processors. These alternative expressions are used interchangeably to describe equivalent structural and functional components.

In certain embodiments, the processor 210 may execute one or more circuitry modules configured to perform the operations corresponding to steps S410, S430, S450, and S470. The feature extraction circuitry may convert parameters of a target neural network into a structured feature representation stored in memory. The parameter retrieval circuitry may compare the structured representation with parameter sets maintained in a parameter repository and retrieve one or more candidate parameter sets based on content-derived similarity metrics. The parameter alignment circuitry may structurally align and rewrite selected parameter sets within memory to generate a reinitialized parameter set. The training circuitry may execute iterative control logic to update and rewrite structured parameter sets stored in memory during controlled training iterations. Accordingly, FIG. 4A represents a processor-controlled training flow in which structured parameter sets are selectively accessed and rewritten under coordinated execution control.

The following describes each step in greater detail.

In certain embodiments, prior to step S410, the neural network learning apparatus 130 may receive a neural network training request signal from the user terminal 110. The training request signal may be generated based on user input received through a dedicated program installed on the user terminal 110.

For example, when a user intends to train a neural network for medical image analysis, the dedicated program of the user terminal 110 may generate a training request signal including at least one of the following information: i) a medical image dataset identifier, ii) input image resolution information, iii) neural network architecture information, and iv) training iteration count or control parameters

The training request signal may be transmitted to the neural network learning apparatus 130 through a communication network. The neural network learning apparatus 130 may receive the training request signal through network interface circuitry and may load the designated training dataset stored in memory 230.

Thereafter, the neural network learning apparatus 130 may set an initial parameter set of a target neural network. The initial parameter set may be a structured parameter set including weights and biases corresponding to layers of the target neural network and may be generated according to a random initialization scheme or loaded from a baseline parameter set previously stored in memory 230. The initial parameter set may be stored in memory 230 and made accessible to the processor 210.

Using the initial parameter set, a preliminary training process may be executed. In particular, the processor 210 may sequentially read input data and corresponding label information stored in memory 230, provide the input data to the target neural network, and generate output results. The processor 210 may compare the output results with the label information to calculate an estimation error value. The estimation error value may be used as control information for updating the structured parameter set stored in memory 230.

The iterative operations may include, for example, (i) providing input data in batch units to generate output results, (ii) calculating an estimation error value based on the output results and the corresponding labels, (iii) determining a parameter update amount based on the estimation error value, and (iv) rewriting at least a portion of the structured parameter set stored in memory 230 to reflect the determined update amount. The above loop may be performed for a predetermined number of iterations, such as mini-batch iterations or epoch iterations, and the updated parameter set may be repeatedly stored back into memory 230.

The preliminary training stage is not intended to achieve full convergence but to partially adjust the parameter set of the target neural network to reflect characteristics of the current dataset and to form a reference state for subsequent feature extraction. The updated structured parameter set generated in this stage may serve as reference information for content-based parameter retrieval performed in step S430.

Accordingly, step S410 may be understood as a processor-controlled system operation in which structured parameter sets stored in memory are repeatedly rewritten under iterative execution control, rather than as a mere abstract algorithmic computation.

Now, the following describes a detailed operational example of step S410.

In certain embodiments, prior to step S410, the neural network learning apparatus 130 may receive a neural network training request signal from the user terminal 110. The training request signal may be generated based on user input through a dedicated program installed on the user terminal 110.

For example, when a user intends to train a neural network for medical image analysis, the dedicated program of the user terminal 110 may generate a training request signal including at least one of a medical image dataset identifier, input image resolution information, neural network architecture information, or training iteration control parameters. The training request signal may be transmitted to the neural network learning apparatus 130 through a communication network, and the neural network learning apparatus 130 may receive the signal through network interface circuitry.

The neural network learning apparatus 130 may load a designated training dataset stored in memory 230 based on the received request signal. The training dataset may include input data and corresponding label information, for example, pairs of input tensors and ground-truth labels.

Next, the neural network learning apparatus 130 may set an initial parameter set of a target neural network and perform preliminary training. The initial parameter set may be a structured parameter set including weights and biases corresponding to respective layers of the target neural network. In certain embodiments, the initial parameter set may be generated according to a random initialization scheme or may be loaded from a baseline parameter set previously stored in memory 230. The initial parameter set may be stored in memory 230 and accessed by the processor 210.

Using the initial parameter set, preliminary training may be executed. For example, the processor 210 may sequentially provide input data stored in memory 230 to the target neural network, generate output results, compare the output results with corresponding label information to calculate an estimation error value, determine a parameter update amount based on the estimation error value, and rewrite at least a portion of the structured parameter set stored in memory 230 to reflect the determined update amount. The above operations may be performed in a loop structure including batch-based input processing, error calculation, parameter update determination, and memory rewriting of the structured parameter set, and such a loop may be repeated for a predetermined number of iterations.

After the preliminary training is performed, the processor 210 or feature extraction circuitry may generate a feature vector from the updated structured parameter set. The feature vector may include numerical information summarizing structural characteristics of the target neural network, such as the number of layers, statistical values of parameters, or structural connection characteristics. The feature vector may be stored in memory 230 and used as reference information for similarity evaluation in step S430.

Now, the following describes a detailed operational example of step S430.

In certain embodiments, step S430 may be performed based on the feature vector generated in step S410. The neural network learning apparatus 130 may read the feature vector of the target neural network stored in memory 230. At the same time, memory 230 may include a parameter repository storing structured parameter sets corresponding to a plurality of previously trained neural networks and feature vectors corresponding to each parameter set.

The processor 210 may compare the feature vector of the target neural network with feature vectors corresponding to respective neural networks stored in the parameter repository. For example, the processor 210 may perform an inner-product-based operation, a distance-based operation, or a cosine similarity operation between two feature vectors to calculate a similarity value. In certain embodiments, a similarity value may be calculated for each comparison result, and the calculated similarity value may be temporarily stored in memory 230.

Based on the calculated similarity values, the processor 210 may select one or more candidate parameter sets. For example, parameter sets having similarity values greater than or equal to a predetermined threshold may be selected, or a predetermined number of top N parameter sets having the highest similarity values may be selected as candidates. The selected candidate parameter sets may be relocated within memory 230 or loaded into a separate working region and may be used as input for structural alignment and rewriting operations performed in step S450.

Accordingly, step S430 may be understood not as an abstract decision-making step of selecting a similar model, but as a processor-controlled system operation in which similarity calculations are performed on a plurality of structured parameter sets stored in memory and specific parameter sets are selected and relocated in memory based on the calculated results.

Now, the following describes a detailed operational example of step S450.

In certain embodiments, step S450 may be a step of adjusting one or more candidate parameter sets selected in step S430 to match the structure of the target neural network. The neural network learning apparatus 130 may compare structural information of the target neural network with structural information corresponding to the candidate parameter sets. The structural information may include, for example, the number of layers, the number of nodes or channels in each layer, connection structures, or activation function types.

The processor 210 may align or transform the candidate parameter sets to conform to the structure of the target neural network based on the structural information. For example, when the number of layers of a candidate parameter set differs from that of the target neural network, parameters corresponding to compatible layers may be mapped while baseline initial parameters may be maintained for non-matching layers. In addition, when the number of channels or nodes differs, certain parameters may be selectively used, or dimension alignment may be performed using interpolation, truncation, or padding operations.

After alignment and transformation are completed, the candidate parameter sets may be reflected in the structured parameter set of the target neural network. For example, the processor 210 may rewrite part or all of the existing structured parameter set stored in memory 230 based on the selected candidate parameter set. In certain embodiments, a new initial parameter set may be generated by combining the candidate parameter set and the existing parameter set according to a predetermined ratio. The generated structured parameter set may be stored in memory 230 and used as an initial state for the training operation performed in step S470.

Accordingly, step S450 may be understood not merely as a parameter replacement step, but as a processor-controlled system operation in which the structure of the target neural network and the structure of the candidate parameter set are compared, and based on such comparison, the structured parameter set stored in memory is aligned, transformed, and rewritten.

Now, the following describes a detailed operational example of step S470.

In certain embodiments, step S470 may be a step of performing training of the target neural network using the reinitialized structured parameter set generated in step S450. The processor 210 may set the reinitialized parameter set stored in memory 230 as an initial state of the target neural network and may perform iterative training operations using the training dataset.

For example, the processor 210 may provide input data to the target neural network on a batch basis, generate output results, compare the output results with corresponding label information to calculate an estimation error value, determine a parameter update amount based on the estimation error value, and rewrite the structured parameter set stored in memory 230 to reflect the updated parameter values.

The training operation may be performed according to iterative control logic. In certain embodiments, the processor 210 may evaluate whether to continue training by examining a change in the estimation error value, the number of iterations performed, or a predefined termination condition. For example, training may be terminated when the estimation error value decreases below a predetermined threshold or when the number of iterations reaches a predefined maximum. Conversely, when reduction of the estimation error stagnates or when a predefined condition is not satisfied, control may return to step S430 to retrieve additional candidate parameter sets.

When training is completed, the processor 210 may store the final updated structured parameter set in memory 230. The final parameter set may subsequently be used for execution of the neural network or for further training operations.

FIG. 4B is a diagram illustrating an execution-oriented structure in which a neural network training method according to the present disclosure retrieves, aligns, rewrites, and iteratively controls structured parameter sets under processor control.

The following describes a detailed operational example of the execution control structure according to FIG. 4B. The execution-oriented training method according to FIG. 4B may include, for example, the following steps. Step B1 may be a step of generating a reference structured parameter set and a feature vector through preliminary training. Step B2 may be a step of accessing a parameter repository storing multiple structured parameter sets and corresponding feature vectors. Step B3 may be a step of performing similarity calculation between the feature vector of a target neural network and feature vectors stored in the repository. Step B4 may be a step of selecting one or more candidate parameter sets based on similarity values. Step B5 may be a step of aligning or transforming the selected candidate parameter sets to match the structure of the target neural network. Step B6 may be a step of generating a reinitialized parameter set by reflecting or combining the aligned candidate parameter sets with an existing parameter set. Step B7 may be a step of performing training using the reinitialized parameter set. Step B8 may be a step of evaluating training status according to iterative control logic and, if necessary, returning to the candidate parameter retrieval step.

The following describes step B1, which is a step of generating a reference parameter set and feature vector through preliminary training.

In certain embodiments, the neural network learning apparatus 130 may receive a training request signal for a multilingual translation model from the user terminal 110. For example, when a user intends to train an English-to-Japanese translation neural network, a dedicated program installed on the user terminal may generate a request signal including at least one of a translation dataset identifier, maximum sentence length, embedding dimension, training iteration count, or control parameters.

Based on the request signal, the neural network learning apparatus 130 may load a multilingual translation training dataset stored in memory 230. The training dataset may include input sentence sequences and corresponding ground-truth translation sequences.

The processor 210 may set an initial structured parameter set of the target translation neural network. The initial parameter set may include weights and biases corresponding to encoder layers and decoder layers of the translation model. In certain embodiments, the initial parameter set may be generated according to a random initialization scheme or loaded from a baseline translation model previously stored in memory 230. The initial parameter set may be stored in memory 230 and accessed by the processor 210.

Using the initial parameter set, the processor 210 may perform preliminary training. For example, the processor 210 may process input sentence sequences in token units to generate output translation sequences, compare the output sequences with the ground-truth sequences to calculate an estimation error value, determine a parameter update amount based on the estimation error value, and rewrite the structured parameter set stored in memory 230 to generate an updated parameter set. Such operations may be performed for a predetermined number of iterations.

After preliminary training is performed, the processor 210 or feature extraction circuitry may generate a feature vector from the updated structured parameter set. The feature vector may include numerical information summarizing structural characteristics of the translation model, such as the number of layers, the number of attention heads, statistical values of parameters, or structural features. The generated feature vector may be stored in memory 230 and used as reference information for similarity calculation in step B3.

The following describes step B2, which is a step of accessing a parameter repository.

In certain embodiments, memory 230 may include a parameter repository storing structured parameter sets corresponding to multiple previously trained translation models and feature vectors corresponding to each parameter set. The processor 210 may read the feature vector of the target translation model generated in step B1 and may also load feature vectors corresponding to each translation model stored in the repository.

The following describes step B3, which is a step of performing similarity calculation between feature vectors.

In certain embodiments, the processor 210 may compare the feature vector of the target translation model with feature vectors corresponding to respective translation models stored in the parameter repository. For example, the processor 210 may perform cosine similarity calculation, inner-product-based operations, or distance-based operations between feature vectors to calculate similarity values. A similarity value may be calculated for each translation model and temporarily stored in memory 230.

The following describes step B4, which is a step of selecting candidate parameter sets.

Based on the calculated similarity values, the processor 210 may select one or more candidate parameter sets. For example, parameter sets having similarity values greater than or equal to a predetermined threshold may be selected, or a predetermined number of top N parameter sets having the highest similarity values may be selected as candidates. The selected candidate parameter sets may be loaded into a working region of memory 230 for further processing in step B5.

The following describes step B5, which is a step of aligning or transforming candidate parameter sets.

In certain embodiments, the processor 210 may compare structural information of the target translation neural network with structural information corresponding to the candidate parameter sets. The structural information may include, for example, the number of encoder and decoder layers, the number of attention heads, embedding dimensions, connection structures, or activation function types.

Based on the comparison, the processor 210 may align or transform the candidate parameter sets to conform to the structure of the target neural network. For example, when the number of attention heads differs, parameters corresponding to compatible heads may be mapped and dimensions may be adjusted as needed. When embedding dimensions differ, dimension alignment may be performed using operations such as interpolation, truncation, or padding. The transformed parameter values may be stored in memory 230.

The following describes step B6, which is a step of generating a reinitialized parameter set.

In certain embodiments, the processor 210 may reflect the aligned candidate parameter set in the structured parameter set of the target neural network. For example, a new initial parameter set may be generated by combining the candidate parameter set and an existing parameter set according to a predetermined ratio. The reinitialized structured parameter set may be stored in memory 230.

The following describes step B7, which is a step of performing training using the reinitialized parameter set.

The processor 210 may set the reinitialized structured parameter set as an initial state of the target translation neural network and may perform iterative training operations using the training dataset. For example, the processor 210 may process input sentence sequences, generate output sequences, calculate estimation error values, determine parameter update amounts, and rewrite the structured parameter set stored in memory 230 to reflect updated parameter values.

The following describes step B8, which is a step of iterative control and re-retrieval.

In certain embodiments, the processor 210 may execute iterative control logic to evaluate the training status. For example, when reduction of the estimation error stagnates, control may return to step B2 or B3 to retrieve additional candidate parameter sets. When a predetermined termination condition is satisfied, training may be terminated and the final updated structured parameter set may be stored in memory 230 at step B9.

Thus, FIG. 4B illustrates a processor-centric execution control architecture in which parameter repository management, feature-vector-based similarity calculation, structural alignment, parameter rewriting, and iterative control are performed within a coordinated system framework.

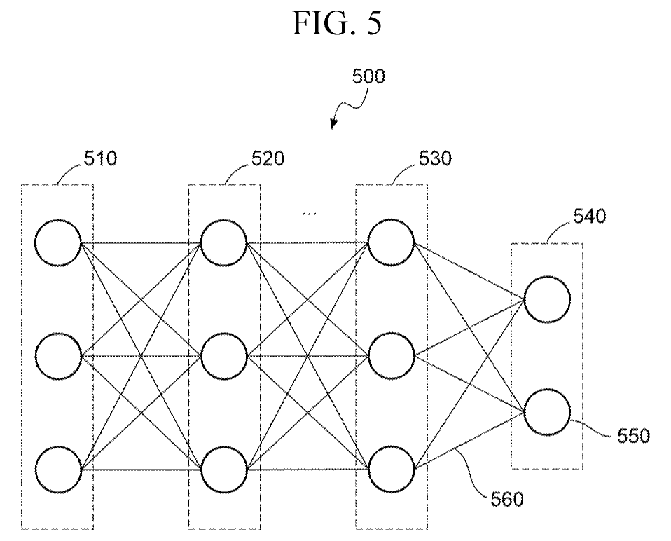

FIG. 5 is a diagram illustrating an embodiment of a model structure of a neural network according to the present disclosure.

Referring to FIG. 5, a neural network 500 may include an input layer 510, one or more hidden layers 520 and 530, and an output layer 540. In this case, each of the input layer 510, the one or more hidden layers 520 and 530, and the output layer 540 may include one or more nodes 550, and each node 550 may be connected through an edge 560. In addition, each node 550 may be assigned a bias, and each edge 560 may be assigned a weight.

The neural network 500 may be trained through neural network learning performed in the neural network learning apparatus 130. For this purpose, the neural network learning apparatus 130 may prepare training data, and the training data may be composed of input data and a label corresponding to the input data. The neural network learning apparatus 130 may initialize weight values and bias values of the neural network 500 for neural network learning, and may update the values through a training process.

Specifically, input data may be input through the input layer 510 of the neural network 500, and each node 550 of the input layer 510 may receive the input data, apply an activation function, and then transmit the result to each node 550 of the next hidden layer 520. In addition, each node 550 of the hidden layers 520 and 530 may apply an activation function to a value received from a previous layer and transmit the result to a next layer, and such a process may be repeated until the output layer 540. Finally, a predicted value may be generated and output from the output layer 540 of the neural network 500.

Meanwhile, the neural network 500 may generate an inference result through a neural network inference process. The neural network 500 may generate a predicted value in the output layer 540 through the same operational process as the training process described above. In this case, the predicted value may take various forms depending on an inference purpose such as classification, regression, or detection.

For purposes of clarity, the weights assigned to the edges 560 and the biases assigned to the nodes 550 illustrated in FIG. 5 may collectively correspond to a structured parameter set stored in non-transitory memory. The structured parameter set may include numerical values representing connection strengths between nodes and bias values associated with respective nodes. These alternative expressions are used interchangeably to describe equivalent structural and functional components.

In certain embodiments, during execution of the neural network training processes described in FIG. 4A and FIG. 4B, a processor may access the structured parameter set corresponding to the neural network 500 from memory and may rewrite at least a portion of the structured parameter set based on calculated parameter update amounts. For example, weight values assigned to edges 560 and bias values assigned to nodes 550 may be modified in accordance with an estimation error calculated during training. The modified parameter values may be stored back into memory, thereby updating the structured parameter set corresponding to the neural network 500.

Accordingly, FIG. 5 illustrates structural elements of a neural network whose associated parameter values are dynamically managed and rewritten within a processor-controlled execution framework. The structural representation shown in FIG. 5 serves as a reference model for understanding how structured parameter sets are accessed, aligned, combined, and iteratively rewritten in the execution control architecture described in FIG. 4A and FIG. 4B.

Hereinafter, a neural network learning method using content-based neural network weights according to the present disclosure will be described in detail.

In an artificial neural network, the connection structure of numerous edges and the weights assigned to each edge may be compared to a memorized way of thinking in the human brain. Accordingly, when a person plans something or estimates a solution to a problem, the person may recall and extract content of a memorized way of thinking directly related or similar to the relevant plan or problem from among previously experienced direct or indirect experiences, and may utilize such thinking ability in establishing the plan or solving the problem.

That is, a person may recall a way of thinking for solving a plan or problem similar to an existing plan or problem, not only for the same plan or problem, and may apply it to solving a new plan or problem. In addition, a person does not newly learn each time to solve the same or similar problem experienced previously, but may recall previous experiences and utilize existing solutions to solve a new problem.

Meanwhile, in a conventional neural network learning method, in order to estimate an answer to given data for problem solving, a process of training a neural network using a large amount of data may be repeated.

Further, a transfer learning method may correspond to a method of reusing a previously trained model for a new problem to improve training speed or reduce training data requirements. The transfer learning method may generally be used in a domain of identical or similar problems. The transfer learning method may fix or fine-tune weights of an existing model and apply them to a new problem. The transfer learning method may be effective mainly when structurally similar neural networks or the same type of data are used.

In the case of the present disclosure, when solving a new problem, neural network data having a similar weight pattern may be automatically retrieved and utilized from a database. This feature may have an advantage of being applicable even when the problem to be solved is not identical or similar to an existing problem. The present disclosure introduces a content-based retrieval concept similar to human memory to find the most similar weights in an existing database and utilize them in neural network learning.

When applying the above concept to a neural network learning method, in a conventional neural network learning method, learning may begin by applying arbitrary initial values to weights of a neural network, or in the case of transfer learning, weights of a previously trained neural network for an identical or similar problem may be introduced and applied as initial values of the neural network, and additional training may be performed using new data.

In contrast, according to the present disclosure, in order to provide a criterion for finding weights having similar characteristics suitable for a new problem, basic neural network learning may first be performed using new training data, and weights having the most similar content to weights according to the basic learning result may be retrieved and introduced from a neural network weight database optimized for various existing problems, and utilized in new neural network learning.

The core of the present disclosure lies in retrieving weights and selecting weights having similar characteristics. In this process, it is not necessary for the neural network to initially have completely trained weights, but in order to provide a criterion for finding weights having similar characteristics suitable for a new problem, basic neural network learning may be required. That is, in the method of the present disclosure, after initially training the neural network, a process of selecting weights having similar characteristics by comparing weights generated from the model with existing weights may be essential. In this process, the present disclosure may automatically retrieve similar weights from an existing database and dynamically utilize them.

According to the present disclosure, the structure of a neural network for a new problem does not need to be identical to an existing neural network structure, and similarity may be automatically calculated and appropriate weights selected by analyzing metadata (structure, purpose, performance, etc.) of an existing neural network. In the present disclosure, the selected weights may be subjected to weight remapping or resizing to fit the new neural network.

According to the present disclosure, the method may be applicable even in different problem domains, and multiple neural networks may be simultaneously referenced to solve or estimate a problem. Further, the present disclosure may be applicable even when the structure or weights are completely different from existing neural networks.

In transfer learning, a person selects an existing model or uses weights of a specific model, and the structure must be similar to that of the existing model, and learning is possible only in identical or similar domains, and a person must design the model and learning method. In addition, transfer learning may be implemented based on a single model and may simply transfer existing memory or knowledge.

According to the present disclosure, after performing basic neural network learning with new training data, a basic weight generated thereby may be used to automatically search an existing weight database and select a similar weight set, and the selected weight may be used as an initial value of a new neural network to perform neural network learning using new data. The present disclosure may be applicable even when the structure of the existing model is completely different by supporting weight remapping and structural adjustment, and existing weights may be utilized even in entirely different domains. The present disclosure may automatically select and adjust weights based on similarity with an existing weight database, and may simultaneously reference or combine weights of multiple neural networks to solve a new problem. The present disclosure may differ from transfer learning in that it utilizes associations similar to recalling memory or ways of thinking similar to previous problem-solving methods, like human brain association functions.

Transfer learning and the present disclosure are similar in that both utilize existing weights, but differ in the learning method. Transfer learning manually selects and adjusts weights already trained in an existing model, whereas the present disclosure automatically retrieves trained neural networks to find and adjust similar weights.

Compared with conventional transfer learning, advantages of the present disclosure may be summarized as follows: (1) automation: the process of retrieving and utilizing existing weights is automated, making it more flexible and applicable to various problems; (2) generality: it may be utilized even when neural network structures and problem domains differ; (3) efficiency: when estimating a new problem or solving a complex problem, weights of multiple existing neural networks may be simultaneously referenced to improve accuracy and learning speed; and (4) memory-based learning: a more human-like approach may be introduced by implementing a principle similar to solving problems based on previous experiences or memory.

The present disclosure may provide a more extensive and automated learning method beyond limitations of transfer learning. In particular, flexibility of neural network structure, applicability across various domains, and a memory-based learning approach may correspond to differentiated strengths.

Since the present disclosure does not search for similar problems in a database, if a neural network is trained assuming problem A but is closer to problem B, more accurate estimation results may be obtained using the learning method of the present disclosure.

In the case of a robot, one robot may perform multiple functions simultaneously. In such a case, weights of neural networks corresponding to various problems previously learned may be retrieved from a database and applied to a new neural network for learning, thereby obtaining multi-functional estimation results. For example, weights of A and B neural networks performing respective functions may be retrieved from a database and used as weights of a new neural network by adding the two neural network weights or applying them with different ratios. In such a case, combined weights may be used as initial values of the new neural network or may be replaced during neural network learning. The method may also be applicable in cases where multiple estimation values exist, such as multi-class classifiers, multi-label classification, or multi-output multi-class classification.

The present disclosure may provide a method of retrieving weights of a neural network to find weights having similar characteristics and utilizing them. Although similar to transfer learning in that existing weights are utilized, the present disclosure may be performed in a more efficient and dynamic manner through automated weight retrieval and application.

In the present disclosure, the neural network may first undergo a basic learning process. The basic learning process is a step of obtaining initial weights of the neural network using new training data to provide a criterion for finding weights having similar characteristics suitable for a new problem. The method of the present disclosure may begin by initializing the neural network in a basic manner and training the neural network using a new training data set until a neural network estimation error becomes less than or equal to a preset value. The criterion for stopping repeated training may be a preset number of iterations or until the estimation error no longer decreases. Through this, the neural network may generate basic weights or a neural network structure for the given problem. In this process, a basic neural network model is constructed, and the model may subsequently be used as a criterion for weight retrieval from an existing neural network model database. The concept of a neural network model may include a neural network structure and weights of edges.

After basic learning is completed, a process of retrieving weights having similar characteristics by comparing with weights stored in an existing database may proceed. In this case, similarity of weights may be measured based on feature vectors or inner product similarity. The method of finding weights having similar characteristics may be implemented in various ways, and for example, differences between the basic weights and existing weights may be measured using Euclidean distance or cosine similarity, and the most similar weight may be automatically selected.

When weights having similar characteristics are found through weight retrieval, the present disclosure may apply the weights to a new neural network to improve performance of the existing model. In this process, selected weights may complement the existing model and may help achieve better performance for new problems or data. At this time, existing weights may be dynamically updated and adjusted to provide appropriate weights for data having new characteristics.

The present disclosure may continuously improve performance of an existing neural network through dynamic weight adjustment. After applying retrieved similar weights, the model may be retrained through a fine-tuning process or retraining. Through this, an ability to adapt to real-time changing data or new problems may be provided, and optimized weights may be continuously secured. Alternatively, after applying existing weights or structures to a new neural network and training with new learning data, generated weights or structures may again be compared and retrieved with weights in an existing weight database to select weights, and the selected weights may be applied again to the new neural network and trained with new learning data, and the process may be repeated. If an estimation error of the neural network further decreases using newly applied existing weights, newly generated neural network weights or structures may be adopted.

A system for implementing the present disclosure may include a neural network learning module, a weight retrieval module, a similarity measurement module, and a dynamic adjustment module. The neural network learning module may perform basic neural network learning, and the weight retrieval module may find weights having similar characteristics in an existing database. The similarity measurement module may evaluate similarity between weights, and the dynamic adjustment module may optimize selected weights and apply them to the neural network.

The present disclosure may be applied to various fields. For example, in an autonomous driving vehicle system, a model may be updated in real time according to vehicle sensor data, and in medical image analysis, a trained model may be dynamically improved according to data for a new disease. Further, in the field of natural language processing, the present disclosure may provide a possibility of automatically constructing an optimized model for new language data.

As described above, in a specific implementation method of the present disclosure, initial learning, weight retrieval, similarity evaluation, and dynamic weight adjustment are described step by step, thereby proposing an automated weight retrieval and application method beyond the concept of transfer learning.

One method for setting weights of a new neural network according to the present disclosure may include: (1) learning a new neural network with new training data and extracting structural features or basic weights of the neural network to provide a criterion for finding weights having similar characteristics suitable for a new problem; (2) retrieving similar structures or similar weights from an existing neural network weight database; (3) adjusting the retrieved structures or weights to fit a new neural network structure; and (4) training the new neural network by using the adjusted weights as initial values.

Through this, learning speed may be improved, initial accuracy may be enhanced, and usability of existing neural networks may be maximized. In addition, since retrieval and utilization are performed according to similar patterns of neural network weights rather than retrieval based on a problem to be solved, degradation of neural network performance due to misinterpretation of problems or misapplication of neural networks may be avoided.

In step (3) described above, weights may be replaced with weights retrieved from an existing database, or weights of a new neural network during learning may be added to weights in the existing database for use. In this case, an addition ratio between the two values may be varied in consideration of a magnitude of an estimation error value of the new neural network or a rate of decrease of the estimation error value. For example, when an estimation error of the new neural network does not decrease rapidly, a proportion of existing weights may be increased.

As another method according to the present disclosure, after sufficiently training a new neural network with new data to determine final weights, similar weights may be found by searching an existing weight database and may be replaced or added, and additional learning may be performed. In this case, since neural network weights of identical or similar problem-solving methods are reflected, overfitting problems may be solved.

An example of a neural network weight retrieval and utilization system proposed in the present disclosure may include the following main modules. A weight database construction module may store weights and structural information of existing neural networks in a database and may generate and store metadata (structure, purpose, performance, domain, etc.) for each neural network, and the database may utilize high-dimensional feature vectors and indexing techniques for efficient retrieval.

Further, a weight retrieval module may retrieve necessary weights from a database when learning a new neural network, may search for weights similar to structural features and meta-information of a new neural network using a content-based retrieval algorithm, and retrieved weights may be provided together with similarity scores such that weights having high similarity may be preferentially selected.

Further, a weight adjustment module may convert retrieved weights to fit a new neural network structure, may generate initialization values suitable for the new neural network structure through weight remapping, resizing, normalization, and the like, and may include a conversion algorithm such that the weights may be utilized even in different domains and neural network structures.

Further, a learning optimization module may train a new neural network based on initialized weights, and when an estimation error during training satisfies a specific condition, may perform additional weight retrieval and updating, and may dynamically combine existing weights and weights generated during learning to optimize learning performance.

Meanwhile, an embodiment of a retrieval algorithm in the present disclosure may be as follows. In a feature extraction step, structural features (number of layers, node connection patterns, etc.) and meta-information (application domain, performance requirements, etc.) of a new neural network may be analyzed, and a feature vector may be generated for comparison with a database. In a similarity calculation step, similarity between a feature vector of each neural network weight stored in the database and a feature vector of the new neural network may be calculated, and cosine similarity, Euclidean distance, or a user-defined similarity function may be used. In a weight selection step, weights may be sorted in descending order of similarity, and top N weights may be selected, and selected weights may be remapped and adjusted according to requirements of the new neural network.

The following are examples of application to various learning scenarios according to the present disclosure. In a single-domain problem, when an existing neural network is specialized in image classification and a new neural network attempts to learn another image dataset, similar weights may be retrieved and used as initialization values. In a multi-domain problem, when a new neural network must simultaneously process image and text data, weights of neural networks trained in respective domains may be retrieved, combined, and used as initialization values. In estimation-error-based learning update, when an estimation error does not decrease during learning, existing weights may be retrieved from a database and weights of a neural network under training may be dynamically adjusted.

The following are examples of weight combination strategies according to the present disclosure. In a simple weight addition case, existing weights and initial weights of a new neural network may simply be added and used. In an error-based ratio adjustment case, the higher the estimation error of a new neural network, the higher a ratio of existing weights may be set. In a domain weight adjustment case, domain relevance of retrieved weights may be evaluated, and higher weights may be assigned to weights having higher relevance.

The following are examples of application cases according to the present disclosure. In medical image analysis, an image analysis team of hospital A is developing a neural network for analyzing lung CT images and diagnosing diseases. However, since time required for data collection and training is limited, it is difficult to optimize neural network performance. According to a method of the present disclosure, first, weights of a neural network trained using existing medical image data may be stored in a database. For example, a “chest X-ray analysis neural network” having weights similar to a lung cancer diagnosis neural network may be stored in the database. Second, after designing and training a new lung CT analysis neural network, weights of an existing neural network having similar characteristics may be retrieved using a weight retrieval module of the present disclosure. Third, retrieved weights may be converted to fit the new neural network structure through a weight adjustment module and used as initialization values. Fourth, the initialized neural network may be trained using lung CT data through a learning optimization module. As a result, learning time may be reduced and diagnostic accuracy may be improved compared to a conventional initialization method.

In an autonomous driving vehicle system, when a vehicle manufacturer is developing a neural network for an autonomous driving system and a new model is to be used in an environment different from an existing neural network (for example, highway instead of city), according to a method of the present disclosure, first, weights of a neural network trained on existing autonomous driving data (city environment) may be stored in a database. Second, a neural network to be trained based on new highway driving data may be designed and trained. Third, similar data corresponding to a highway driving environment may be retrieved from existing neural network weights using a weight retrieval module. In this case, the database may provide retrieval results based on highway-related meta-information (road type, vehicle speed, etc.). Fourth, retrieved weights may be converted to be suitable for the new environment using a weight adjustment module. Fifth, the initialized neural network may be trained and optimized using highway data. As a result, the autonomous driving system may provide faster learning speed and ensure stable driving performance in a new environment.

In a multi-domain translation system, when a language translation company is developing a multilingual translation system and a new neural network must learn an English-Japanese translation model by utilizing previously trained weights (English-Korean and English-Chinese translation), according to a method of the present disclosure, first, weights of existing translation neural networks (English-Korean and English-Chinese) may be stored in a database. Second, a new English-Japanese translation neural network may be designed and trained, and similar translation model weights may be retrieved using a weight retrieval module. Third, among English-Korean and English-Chinese weights, weights having similar grammatical structure and word order characteristics may be preferentially selected. Fourth, retrieved weights may be combined using a weight combination strategy and used as initialization values. Fifth, learning optimization may be performed using new data. As a result, initial translation quality (based on BLEU score) may be improved compared to a conventional initialization method, and overall learning time may be significantly reduced.

In a customized recommendation system, when an e-commerce platform is developing a personalized recommendation system and a new neural network must learn an advanced recommendation algorithm based on user purchase patterns and behavior data, according to a method of the present disclosure, first, weights of existing neural networks (book, clothing, electronics recommendations) may be stored in a database. Second, a new neural network may design a structure for analyzing data of a specific user group (for example, sports goods purchasers). Third, weights of a recommendation system having similar purchase patterns may be retrieved through a weight retrieval module. Fourth, retrieved weights may be converted to fit characteristics of the new user group through a weight adjustment module. Fifth, learning may be performed using the initialized neural network to optimize a sports goods recommendation system. As a result, recommendation accuracy and user click-through rate may increase compared to a conventional initialization method.

Accordingly, the weight retrieval and utilization system according to the present disclosure may maximize efficiency of neural network learning by enabling reduction of learning time, improvement of initial performance, and optimization of data utilization.

For purposes of clarity, the term “weight” as used herein may refer to a structured parameter set including numerical values corresponding to connections and nodes of a neural network, and such structured parameter sets may be stored in non-transitory memory and accessed by one or more hardware processors. The term “weight database” may correspond to a parameter repository storing structured parameter sets and associated feature vectors of previously trained neural networks. The terms “weight retrieval module,” “similarity measurement module,” “weight adjustment module,” and “learning optimization module” may be implemented as functional components executed by one or more processors within a neural network training system including hardware processors and memory storing executable instructions. These expressions are used interchangeably to describe equivalent structural and functional components.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present disclosure can be embodied in the form of methods and apparatuses for practicing those methods. The present disclosure can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present disclosure can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present disclosure can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

No claim element herein is to be construed under the provisions of 35 U.S.C. § 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A computer-implemented neural network learning method using content-based neural network parameter sets, performed by at least one hardware processor operatively coupled to a non-transitory memory, the method comprising:
reading, by the at least one hardware processor, a structured parameter set corresponding to a given neural network from the non-transitory memory;
extracting, by the at least one hardware processor, one or more features representing structural or parametric characteristics of the given neural network;
retrieving, by the at least one hardware processor, one or more candidate structured parameter sets from a parameter repository stored in the non-transitory memory by using at least some of the one or more features as a search key;
adjusting, by the at least one hardware processor, the one or more candidate structured parameter sets to conform to a structure of the given neural network; and
rewriting, by the at least one hardware processor, at least a portion of the structured parameter set of the given neural network in the non-transitory memory by applying the adjusted structured parameter sets as initial parameter values, and performing training of the given neural network using the rewritten structured parameter set.

2. A neural network training system using content-based neural network parameter sets, comprising:
at least one hardware processor; and a non-transitory memory storing executable instructions and a parameter repository including structured parameter sets corresponding to a plurality of pre-constructed neural networks,
wherein the executable instructions, when executed by the at least one hardware processor, cause the at least one hardware processor to:
extract one or more features representing structural or parametric characteristics of a given neural network;
retrieve one or more candidate structured parameter sets from the parameter repository by using at least some of the one or more features as a search key;
adjust the one or more candidate structured parameter sets based on a structure of the given neural network; and
rewrite at least a portion of a structured parameter set stored in the non-transitory memory and train the given neural network using the rewritten structured parameter set.

3. A non-transitory computer-readable recording medium storing a computer program which, when executed by at least one hardware processor operatively coupled to a non-transitory memory, causes the at least one hardware processor to:
read a structured parameter set corresponding to a given neural network from the non-transitory memory;
extract one or more features representing structural or parametric characteristics of the given neural network;
retrieve one or more candidate structured parameter sets from a parameter repository stored in the non-transitory memory by using at least some of the one or more features as a search key;
adjust the one or more candidate structured parameter sets to conform to a structure of the given neural network; and
rewrite at least a portion of the structured parameter set of the given neural network in the non-transitory memory by applying the adjusted structured parameter sets as initial parameter values, and perform training of the given neural network using the rewritten structured parameter set.
